(19) United States
(12) Patent Application Publication
(10) Pub. No.: US 2026/0124886 A1
(43) Pub. Date: May 7, 2026

(54) SLIDING WINDOW, VEHICLE WINDOW ASSEMBLY, AND VEHICLE

(71) Applicant: FUJIAN FUYAO AUTOMOTIVE TRIM SYSTEM CO., LTD., Fuzhou (CN)

(72) Inventors: Fangmin YU, Fuqing (CN); Yan LIN, Fuqing (CN); Shaoyi QIU, Fuqing (CN)

(21) Appl. No.: 19/365,483

(22) Filed: Oct. 22, 2025

(30) Foreign Application Priority Data
Nov. 4, 2024 (CN) 202411557656.3

(51) Int. Cl. B60J 1/08; B60J 1/16; B60J 1/20

(52) U.S. Cl. CPC B60J 1/085; B60J 1/16; B60J 1/2011

(57) ABSTRACT

A sliding window includes a window frame and a glass. The window frame includes a first frame strip and a second frame strip that are arranged side by side and spaced apart from each other. The first frame strip includes a limiting lock, a first profile and a second profile. The first profile is arranged on a side of the second profile adjacent to the second frame strip. The first profile and the second profile are removably assembled and matched. The limiting lock is configured to lock or unlock the first profile and the second profile. The glass has a first side portion and a second side portion opposite to each other. The first side portion is connected to the first profile, and the second side portion is detachably connected to the second frame strip.

### CROSS REFERENCES TO RELATED APPLICATION

This application claims priority to Chinese patent application No. 2024115576563, filed on November 4, 2024, entitled “SLIDING WINDOW, VEHICLE WINDOW ASSEMBLY, AND VEHICLE”, the content of which is hereby incorporated by reference in its entirety.

### TECHNICAL FIELD

The present disclosure relates to the technical field of window structures, particularly to a sliding window, a vehicle window assembly, and a vehicle.

### BACKGROUND

Special vehicles such as police cars and escort vehicles often utilize a special window structure. This window consists of a large window glass and a sliding window mounted on the glass. A window is provided on the window glass at a location corresponding to the sliding window. The sliding window can be opened or closed by pushing or pulling the sliding window, allowing passengers inside the vehicle to observe the exterior environment and ventilate the vehicle.

In actual use, if the glass of the sliding window is damaged, it must be removed for replacement. Traditional technologies require specialized tools such as screwdrivers to remove numerous components due to the complex glass mounting structure. This cumbersome, time-consuming, and labor-intensive process fails to meet user needs for quick removal of the glass.

### SUMMARY

Therefore, it is necessary to provide a sliding window, a vehicle window assembly, and a vehicle to address the problems of the cumbersome, time-consuming, and labor-intensive removal process of the glass.

In a first aspect, the present disclosure provides a sliding window, including a window frame and a glass. The window frame includes a first frame strip and a second frame strip that are arranged side by side and spaced apart from each other. The first frame strip includes a limiting lock, a first profile and a second profile. The first profile is arranged on a side of the second profile adjacent to the second frame strip, the first profile and the second profile is removably assembled, and the limiting lock is configured to lock or unlock the first profile and the second profile. The glass has a first side portion and a second side portion that are opposite to each other, the first side portion is connected to the first profile, and the second side portion is detachably connected to the second frame strip. After the limiting lock unlocks the first profile and the second profile, the second profile is separated from the first profile, thereby allowing the glass to be detached from the second frame strip.

During normal assembly and use of the aforementioned sliding window, the first side portion of the glass is connected to the first profile, while the second side portion is connected to the second frame strip. The limiting lock is then operated to lock the first profile and second profile, thereby enabling the first profile and second profile to be assembled fixedly. The first profile cannot move relative to the second profile, resulting in a first frame strip with a stable overall structure, thereby enabling the glass to be securely fixed. When the glass is damaged and needs to be removed, the limiting lock is first operated to unlock the first profile and second profile, allowing the second profile to separate from the first profile. The first profile is then capable of being detached from the glass, and the glass is capable of being removed from the second frame strip, or both the first profile and the glass is capable of being directly removed from the second frame strip, thus the removal operation of the glass can be completed. Compared to conventional disassembly methods that require a screwdriver, this solution does not require specialized tools for disassembly of the glass. The removal process is simple, saving time and effort, and can be completed quickly, meeting users' needs for quick removal of the glass and enhancing the user experience.

In one of the embodiments, the first profile is provided with a limit block on a side surface thereof facing the second profile. The second profile is provided with a sliding groove and a notch in communication with each other. The limit block is slidably disposed within the sliding groove, and after the limiting lock unlocks the first profile and the second profile, the first profile slides relative to the second profile in a predetermined direction, so as to drive the limit block to slide from the sliding groove to the notch, thereby allowing the limit block to be released from the notch.

In one of the embodiments, the limiting lock includes a lock seat, a lock handle, and a lock tongue. The lock seat is disposed on the second profile. The lock handle is rotatably disposed on the lock seat and is connected to the lock tongue. The first profile is provided with a lock opening. The limiting lock has a locked state locking the first profile and the second profile, and an unlocked state unlocking the first profile and the second profile. When the limiting lock is in the locked state, the lock tongue is engaged in the lock opening, and when the limiting lock is in the unlocked state, the lock tongue is withdrawn from the lock opening.

In one of the embodiments, the limiting lock includes a lock seat, a lock handle, and a lock tongue. The lock seat is disposed on the first profile. The lock handle is rotatably disposed on the lock seat and is connected to the lock tongue. The second profile is provided with a lock opening. The limiting lock has a locked state locking the first profile and the second profile, and an unlocked state unlocking the first profile and the second profile. When the limiting lock is in the locked state, the lock tongue is engaged with the lock opening, and when the limiting lock is in the unlocked state, the lock tongue is withdrawn from the lock opening.

In one of the embodiments, the limiting lock includes a lock seat, a lock handle, and a lock tongue. The lock seat is disposed on the second profile. The lock handle is rotatably mounted on the lock seat and connected to the lock tongue. The first profile is provided with a lock latch. The lock latch is provided with a lock opening and a surface of the lock latch is provided with an unlock indicator.

The limiting lock has a locked state locking the first profile and the second profile, and an unlocked state unlocking the first profile and the second profile. When the limiting lock is in the locked state, the lock tongue is engaged in the lock opening, and the lock handle is pressed against the lock latch; when the limiting lock is in the unlocked state, the lock tongue is withdrawn from the lock opening.

In one of the embodiments, the limiting lock includes a baffle, a lock block, and a threaded component. The second profile is provided with an engaging opening. The lock block is provided with a hook portion and a threaded hole. The lock block is mounted on the baffle. The hook portion is engaged in the engaging opening. The threaded component extends through a through hole of the baffle and is screwed into the threaded hole. The threaded component presses the baffle such that the baffle abuts against a same ends of the first profile and the second profile.

In one of the embodiments, an outer peripheral wall of the limit block is provided with a conical surface. Opposite side wall of the sliding groove are provided with inclined surfaces, and the inclined surfaces are configured to be engaged with the conical surface.

In one of the embodiments, the first frame strip further includes a stop block, and the stop block is arranged on a side of the notch away from the sliding groove along the predetermined direction.

In one of the embodiments, the first frame strip further includes a first sealing member. The first profile is provided with a first mounting groove on a side surface facing the second frame strip, and the first sealing member is received in the first mounting groove and is connected to the first side portion.

In one of the embodiments, the sliding window further includes a side frame strip and a second sealing member. Opposite ends of the side frame strip are connected to an end of the first frame strip and an end of the second frame strip, respectively. The side frame strip is provided with a second mounting groove, and the second sealing member is received in the second mounting groove and is detachably connected to a third side portion of the glass.

In one of the embodiments, the sliding window further includes a middle frame strip and a third sealing member. The middle frame strip is movably disposed between the first frame strip and the second frame strip. The middle frame strip is provided with a third mounting groove, and the third sealing member is disposed in the third mounting groove and is connected to a fourth side portion of the glass.

In one of the embodiments, the sliding window further includes a window lock disposed on the glass. The second frame strip is provided with a plurality of engaging openings arranged spaced apart on the second frame strip along a sliding direction of the glass, and the window lock is capable of locking or unlocking with any of the plurality of engaging openings.

In one of the embodiments, the sliding window further includes a guide strip and a slider. The guide strip is provided with a guide groove, and the slider is embedded with the guide groove and is capable of sliding on the second frame strip.

In a second aspect, the present disclosure provides a vehicle window assembly, including a laminated glass and the sliding window according to any one of the aforementioned embodiments.

The laminated glass is provided with a window opening. The sliding window is disposed on the laminated glass corresponding to the window opening. The glass is capable of opening or closing the window opening.

In one of the embodiments, the laminated glass includes an inner sheet glass, an outer sheet glass, an anti-UV film, and a soundproofing film. The anti-UV film and the soundproofing film are laminated and sandwiched between the inner sheet glass and the outer sheet glass.

In one of the embodiments, the outer sheet glass is made of chemically strengthened glass, and the inner sheet glass is made of semi-tempered glass.

In one of the embodiments, the vehicle window assembly further includes a grille member and a decorative cover. The grille member is mounted in the window opening. The laminated glass further includes a drain outlet, and the decorative cover covers the drain outlet.

In a third aspect, the present disclosure provides a vehicle, including a vehicle body and the vehicle window assembly according to any one of the aforementioned embodiments. The vehicle window assembly is provided on the vehicle body.

### BRIEF DESCRIPTION OF THE DRAWINGS

The accompanying drawings that constitute a part of the present disclosure are used to provide a further understanding of the present disclosure. Schematic embodiments of the present disclosure and descriptions thereof are used to explain the present disclosure, and do not constitute improper limitations of the present disclosure.

To describe the technical solutions in the embodiments of the present disclosure more clearly, the following briefly describes the accompanying drawings required for describing the embodiments. Apparently, the accompanying drawings in the following description show merely some embodiments of the present disclosure, and those who skill in the art may still derive other drawings from these accompanying drawings without creative efforts.

FIG. 1 is an exploded view of a sliding window according to an embodiment.

FIG. 2 is an enlarged partial view of portion A in FIG. 1.

FIG. 3 is a detailed view of a limiting lock locking a first profile according to an embodiment.

FIG. 4 is an exploded view of a vehicle window assembly according to an embodiment.

FIG. 5 is an exploded view of a laminated glass, a grille member, and a decorative cover shown in FIG. 4.

FIG. 6 is an enlarged partial view of portion B in FIG. 5.

FIG. 7 is a perspective view of the sliding window.

FIG. 8 is a cross-sectional view taken along line C-C in FIG. 7.

FIG. 9 is an enlarged partial view of portion D in FIG. 8.

FIG. 10 is an enlarged partial view of portion E in FIG. 8.

FIG. 11 is an exploded view of a limiting lock according to another embodiment.

FIG. 12 is a cross-sectional view of portion F in FIG. 7.

FIG. 13 is an enlarged partial view of portion G in FIG. 12.

### Description of the Reference Numerals:

100: vehicle window assembly;

10: sliding window;

11: first frame strip;

111: limiting lock;

111a: lock seat;

111b: lock handle;

111c: lock tongue;

111d: baffle;

111e: lock block;

111f: threaded component;

112: first profile;

112a: lock latch;

1121a: lock opening;

1122a: unlock indicator;

112b: first mounting groove;

113: second profile;

113a: sliding groove;

113b: notch;

114: stop block;

115: threaded component;

116: first sealing member:

12: second frame strip;

121: engaging opening;

13: limit block;

131: conical surface;

14: glass;

141: first side portion;

142: second side portion;

143: third side portion;

144: fourth side portion;

15: side frame strip;

16: middle frame strip;

17: second sealing member;

18: third sealing member;

19: window lock;

19a: guide strip;

19b: slider;

20: laminated glass;

21: window opening;

22: inner sheet glass;

23: outer sheet glass;

24: anti-UV film;

25: soundproofing film;

26: drain outlet;

30: grille member;

40: decorative cover.

### DETAILED DESCRIPTION OF THE EMBODIMENTS

In order to make the aforementioned objects, features and advantages of the present disclosure more clearly understood, the specific embodiments of the present disclosure will be described in detail below with reference to the accompanying drawings. In the following description, numerous specific details are set forth in order to provide a thorough understanding of the present disclosure. However, the present disclosure can be implemented in many other ways different from those described herein, and those skilled in the art can make similar improvements without departing from the connotation of the present disclosure. Therefore, the present disclosure is not limited by the specific embodiments disclosed below.

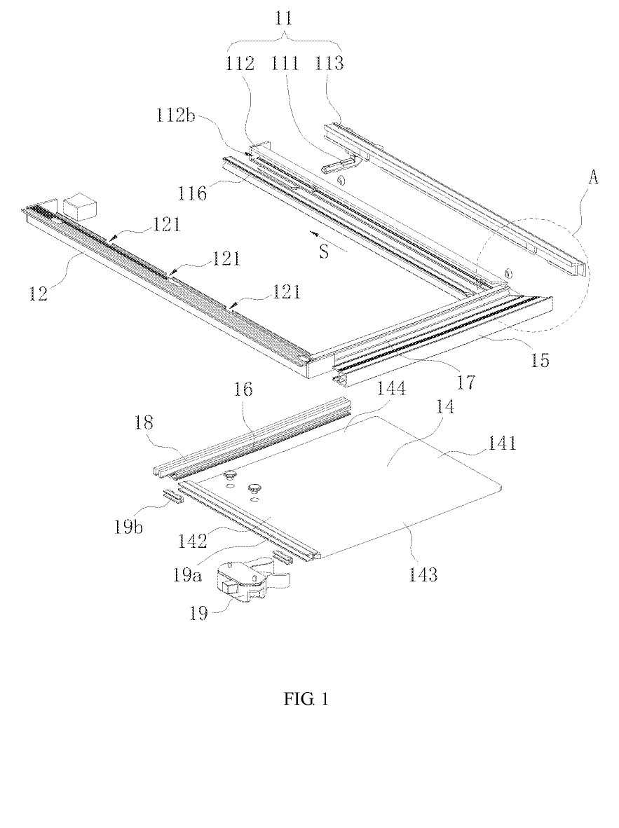

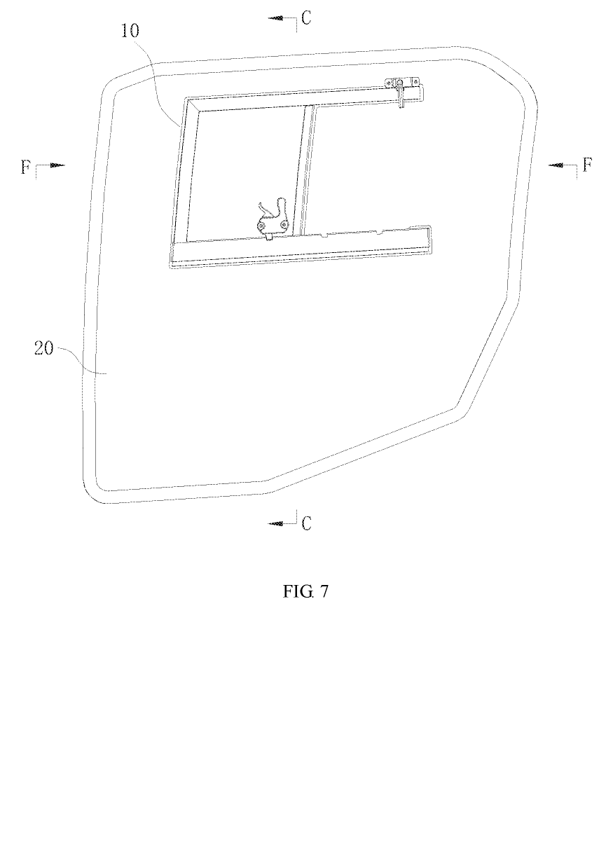

FIG. 1 is an exploded view of a sliding window 10 in accordance with an embodiment of the present disclosure, and FIG. 7 is a perspective view of the sliding window 10. The sliding window 10 includes a window frame and a glass 14. The glass 14 may be either a single-layer glass or a laminated glass, and may be transparent glass, translucent glass, or privacy glass, which can be flexible selected based on actual needs.

In the illustrated embodiment, the window frame is substantially rectangular and includes a first frame strip 11 and a second frame strip 12 that are arranged side by side and spaced apart. For example, the first frame strip 11 and the second frame strip 12 may be two long side strips extending in a width direction of the window frame.

Referring to FIG. 1 to FIG. 3, the first frame strip 11 includes a limiting lock 111, a first profile 112, and a second profile 113. The first profile 112 is disposed on a side of the second profile 113 adjacent to the second frame strip 12. The first profile 112 and the second profile 113 are removably assembled. The limiting lock 111 is configured to lock or unlock the first profile 112 and the second profile 113. In one embodiment, the limiting lock 111 has a locked state locking the first profile 112 and the second profile 113, and an unlocked state unlocking the first profile 112 and the second profile 113. The glass 14 includes a first side portion 141 and a second side portion 142 that are opposite to each other. The first side portion 141 is connected to the first profile 112, and the second side portion 142 is detachably connected to the second frame strip 12. After the limiting lock 111 unlocks the first profile 112 and the second profile 113, the second profile 113 is separated from the first profile 112, such that the glass is capable of being detached from the second frame strip 12.

During normal assembly and use of the aforementioned sliding window 10, the first side portion 141 of the glass 14 is connected to the first profile 112, while the second side portion 142 is connected to the second frame strip 12. The limiting lock 111 is then operated to lock the first profile 112 and second profile 113, thereby enabling the first profile 112 and second profile 113 to be assembled fixedly. The first profile 112 cannot move relative to the second profile 113, resulting in the first frame strip 11 with a stable overall structure, thereby enabling the glass 14 to be securely fixed. When the glass 14 is damaged and needs to be removed, the limiting lock 111 is first operated to unlock the first profile 112 and second profile 113, thus allowing the second profile 113 to separate from the first profile 112. The first profile 112 can be detached from the glass 14, and the glass 14 can be removed from the second frame strip 12, or both the first profile 112 and glass 14 can be removed from the second frame strip 12, thus the removal operation of the glass 14 is completed. Compared to conventional removal methods that require a screwdriver, this solution does not require specialized tools for disassembly of the glass 14. The removal process is simple, saving time and effort, and the removal operation of the glass 14 can be completed quickly, meeting users' needs for quick removal of the glass 14 and enhancing the user experience.

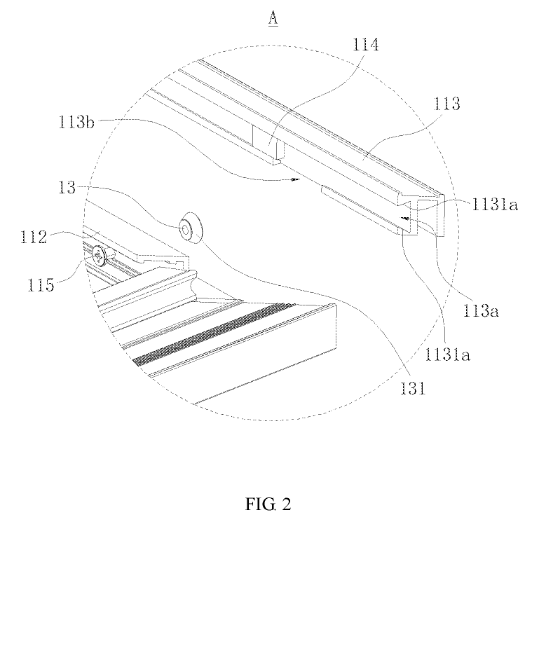

Referring to FIG. 1 and FIG. 2, in an optional embodiment, the first profile 112 is provided with a limit block 13 on a side surface thereof facing the second profile 113. The second profile 113 is provided with a sliding groove 113a and a notch 113b in communication with each other. The limit block 13 is disposed within the sliding groove 113a. After the limiting lock 111 unlocks the first profile 112 and the second profiles 113, the first profile 112 slides relative to the second profile 113 in a predetermined direction (as indicated by arrow S in FIG. 1), thereby driving the limit block 13 from the sliding groove 113a to the notch 113b. The limit block 13 can then be disengaged from the notch 113b, such that the first profile 112 and the second profiles 113 can be separated. On this time, the first profile 112 and the glass 14 can be removed from the second frame strip 12, either sequentially or simultaneously.

The limit block 13 is inserted into the notch 113b and slides in an opposite direction of the predetermined direction to be engaged into the sliding groove 113a, such that the first profile 112 and the second profile 113 are assembled fixedly. Finally, the limiting lock 111 is locked. The limiting lock 111 locks the first profile 112, such that the first profile 112 cannot move relative to the second profile 113, thereby obtaining the first frame strip 11 with a stable overall structure. As such, the glass 14 can be mounted and fixed. When the glass 14 is damaged and needs to be removed, the limiting lock 111 is first operated to unlock the first profile 112, and then the first profile 112 is pushed to slide relative to the second profile 113 in the predetermined direction. The first profile 112 simultaneously drives the limit block 13 to slide from the sliding groove 113a to the notch 113b. Then, the glass 14 and the first profile 112 are pulled outward, and the limit block 13 can be removed from the notch 113b. At this time, the first profile 112 is completely separated from the second profile 113. Finally, the glass 14 and the first profile 112 are pulled upward, such that the second side portion 142 of the glass 14 is separated from the second frame strip 12, thereby completing the removal of the glass 14.

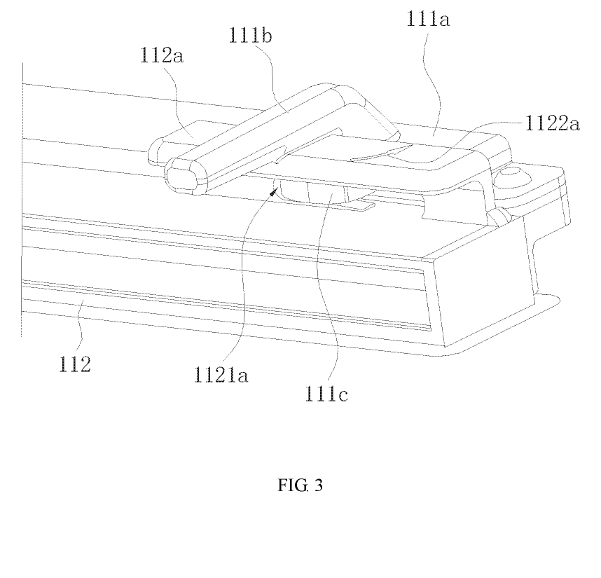

Referring to FIG. 2 to FIG. 3, in an embodiment, the limiting lock 111 includes a lock seat 111a, a lock handle 111b, and a lock tongue 111c. The lock seat 111a is disposed on the second profile 113. The lock handle 111b is rotatably disposed on the lock seat 111a and is connected to the lock tongue 111c, such that the lock tongue 111c can move with the lock handle 111b. The first profile 112 is provided with a lock opening 1121a. When the limiting lock 111 is in the locked state, the lock tongue 111c is engaged within the lock opening 1121a. When the limiting lock 111 is in the unlocked state, the lock tongue 111c is withdrawn from the lock opening 1121a.

Alternatively, in another embodiment, the limiting lock 111 includes a lock seat 111a, a lock handle 111b, and a lock tongue 111c. The lock seat 111a is disposed on the first profile 112. The lock handle 111b is rotatably disposed on the lock seat 111a and is connected to the lock tongue 111c, such that the lock tongue 111c can move with the lock handle 111b. The second profile 113 defines a lock opening 1121a. When the limiting lock 111 is in the locked state, the lock tongue 111c is engaged within the lock opening 1121a. When the limiting lock 111 is in the unlocked state, the lock tongue 111c is withdrawn from the lock opening 1121a.

In the aforementioned embodiment, the lock seat 111a is disposed on the first profile 112, and the second profile 113 is provided with the lock opening 1121a. It should be understood that, when the lock tongue 111c is inserted into the lock opening 1121a, and the limiting lock 111 is in the locked state, the limit block 13 is also engaged in the sliding groove 113a, thus preventing the first profile 112 from sliding relative to the second profile 113 in the predetermined direction. This ensures a secure assembly and a secure positioning of the first profile 112 and the second profiles 113, thus ensuring the overall structural stability of the sliding window 10. The glass 14 slides relative to the first frame strips 11 and the second frame strips 12 via the first side portion 141 and second side portion 142, allowing the sliding window 10 to be opened or closed. Conversely, when the lock handle 111b is rotated to push the lock tongue 111c out of the lock opening 1121a, the limiting lock 111 is unlocked, allowing the first profile 112 to slide relative to the second profile 113 in the predetermined direction, and the limit block 13 can be released from the notch 113b, thus facilitating removal of the first profile 112 and glass 14. The rotational operation of the limiting lock 111 is simple and highly implementable.

Referring to FIG. 3, as an alternative solution to the two aforementioned embodiments, in another embodiment, the limiting lock 111 includes a lock seat 111a, a lock handle 111b and a lock tongue 111c. The lock seat 111a is disposed on the second profile 113. The lock handle 111b is rotatably disposed on the lock seat 111a and is connected to the lock tongue 111c, such that the lock tongue 111c can move with the lock handle 111b. The first profile 112 is provided with a lock latch 112a. The lock latch 112a is provided with a lock opening 1121a, and an unlock indicator 1122a is provided on a visible surface of the lock latch 112a.

When the limiting lock 111 is in the locked state, the lock tongue 111c is engaged within the lock opening 1121a, and the lock handle 111b is pressed against the lock latch 112a. When the limiting lock 111 is in the unlocked state, the lock tongue 111c is withdrawn from the lock opening 1121a.

Compared to the aforementioned embodiment, the main operating principles and methods of the limiting lock 111 are essentially the same. The differences lies in that: first, by providing the unlock indicator 1122a on the visible surface of the lock latch 112a (e.g., an outer surface of the lock latch 112a away from the second profile 113), the user is explicitly informed of the specific direction in which to rotate the lock handle 111b for the unlock operation (rotate in the opposite direction to lock), thereby improving operational efficiency and accuracy.

For example, the unlock indicator 1122a may be, but is not limited to, an arrow, and the orientation of the arrow refers to the unlocking direction, and the direction opposite the orientation of the arrow refers to the locking direction.

In addition, when the limiting lock 111 is in the locked state, an inner surface of the lock handle 111b is pressed against an outer surface of the lock latch 112a to generate a frictional retaining force, thus improving the stability and reliability of the lock handle 111b to be maintained in the locked position, preventing accidental unlocking due to environmental vibrations and other factors, which may compromise the overall structural stability of the sliding window 10.

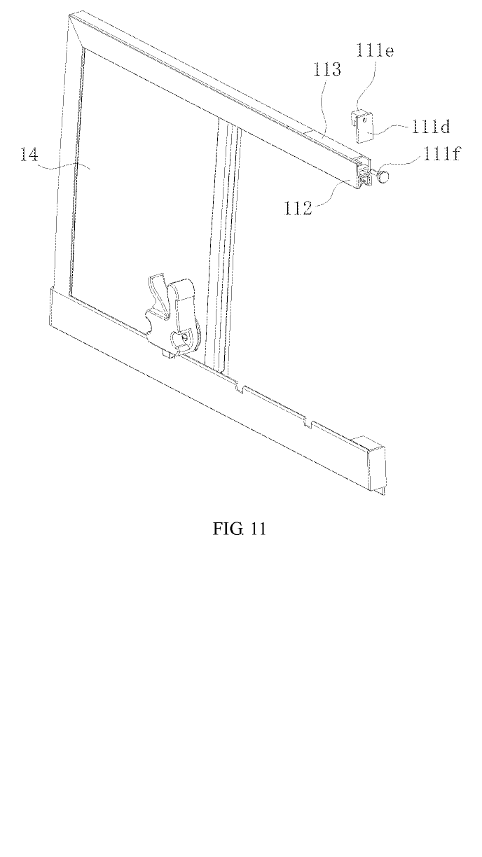

Referring to FIG. 11, the limiting lock 111 has various modifications. Specifically, in another embodiment, the limiting lock 111 includes a baffle 111d, a lock block 111e, and a threaded component 111f. The second profile 113 is provided with an engaging opening. The lock block 111e is provided with a hook portion and a threaded hole. The lock block 111e is mounted on the baffle 111d, and the hook portion is engaged within the engaging opening. The threaded component 111f extends through a through hole of the baffle 111d and is threadedly engaged within the threaded hole. The threaded component 111f presses against the baffle 111d, causing the baffle 111d to abut against the same end of the first profile 112 and the second profile 113.

After the first profile 112 and the second profile 113 are assembled and the threaded component 111f is tightened, the hook portion engaged within the engaging opening and the baffle 111d simultaneously clamp the first profile 112 and the second profile 113, ensuring that the baffle 111d is securely mounted and abuts against the same end of the first profile 112 and the second profile 113, thereby limiting the position of the first profile 112 and the second profile 113. On this basis, the limit block 13 is engaged within the sliding groove 113a, thereby ensuring that the first profile 112 and the second profile 113 are securely and reliably assembled, thereby forming the first frame strip 11 with a stable structure. When the glass 14 needs to be removed, the threaded component 111f is loosened, and the limiting lock 111 can be completely removed from the first frame strip 11. The abutting and limiting functions of the baffle 111d is removed. The first profile 112 can then slide to release the limit block 13 from the notch 113b, the second profile 113 from the first profile 113 can be detached, allowing the glass 14 to be removed.

Referring to FIG. 2, in addition, on the basis of any of the aforementioned embodiments, an outer peripheral wall of the limit block 13 is provided with a conical surface 131, and opposite sides of the sliding groove 113a are provided with inclined surfaces 1131a. The inclined surface 1131a can be engaged with the conical surface 131. The cooperation of the inclined surface 1131a and the conical surface 131 facilitates the sliding of the limit block 13 into and out of the sliding groove 113a, preventing problems such as jamming during movement. Further, when the limit block 13 is engaged within the sliding groove 113a, the limit block 13 can be reliably prevented from being forced out of the sliding groove 113a.

Further, the first frame strip 11 includes a stop block 114, which is arranged on a side of notch 113b away from sliding groove 113a along the predetermined direction. When the limit block 13 slides with the first profile 112 and slides synchronously from the sliding groove 113a to the notch 113b, the stop block 114 precisely blocks the limit block 13, realizing the positioning of the limit block 13, thus ensuring the limit block 13 stops precisely within notch 113b, allowing the limit block 13 to be smoothly and effectively removed from the notch 113b.

Optionally, the stop block 114 is secured to the second profile 113 via at least one of screwing, clamping, magnetic connection, and adhesive bonding.

To secure the limit block 13 to the first profile 112, in one optional embodiment, the first frame strip 11 further includes a threaded component 115, and the limit block 13 is secured to the first profile 112 via the threaded component 115. For example, the threaded component 115 may be, but is not limited to, a screw or a bolt.

In other optional embodiments, the limit block 13 may be secured to the first profile 112 using any of the following methods: clamping, riveting, welding, or adhesive bonding, with the preferred method being flexible and suitable for practical application.

In the illustrated embodiment, there are two limit blocks 13, two sliding grooves 113a, two notches 113b, and two stop blocks 114 assembled in a one-to-one manner. The two limit blocks 13 are arranged at both ends of the length direction of the first profile 112, respectively. As such, when the first profile 112 and the second profile 113 are locked together, the first profile 112 is uniformly stressed, and the lock with the second profile 113 is reliable and tight, with high connection strength. When the glass 14 is removed, the first profile 112 slides smoothly and stably relative to the second profile 113, and is not inclined to one end and cause jamming.

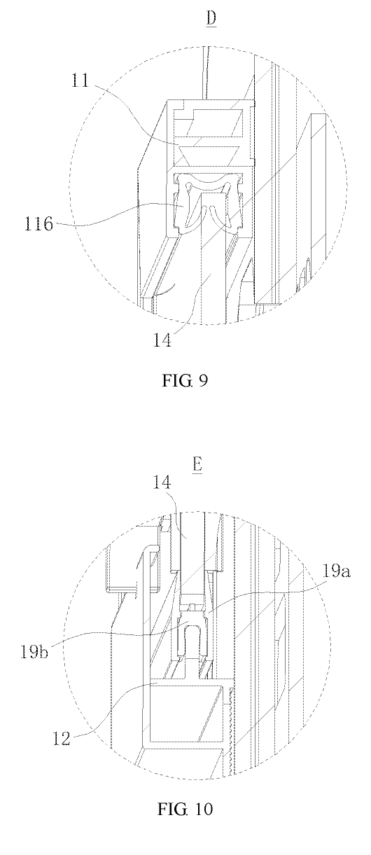

Referring to FIG. 1 and FIG. 9, further, in yet another embodiment, the first frame strip 11 further includes a first sealing member 116. The first profile 112 is provided with a first mounting groove 112b on a side surface thereof facing the second frame strip 12. The first sealing member 116 is received in the first mounting groove 112b and is connected to the first side portion 141. During mounting, the first sealing member 116 is first mounted into the first mounting groove 112b. The first side portion 141 of the glass 14 is then inserted into the first mounting groove 112b and plugged into the first sealing member 116. On the one hand, mounting and positioning of the glass 14 is realized, the stability of the glass 14 is improved and movement of the glass 14 is prevented during pushing and pulling. On the other hand, the first sealing member 116 prevents direct sliding friction wear between the glass 14 and the first profile 112, thereby preventing any abnormal noise and extending component life.

It should be noted that during assembly and disassembly operations, the first sealing member 116 must be removed or mounted together with the first profile 112, so as to prevent the glass 14 from squeezing the first sealing member 116 during the mounting of the glass 14, which could cause defects such as push-pull curling of the first sealing member 116.

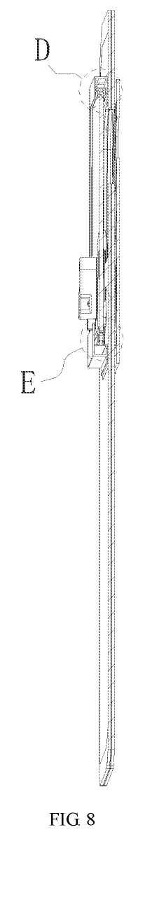

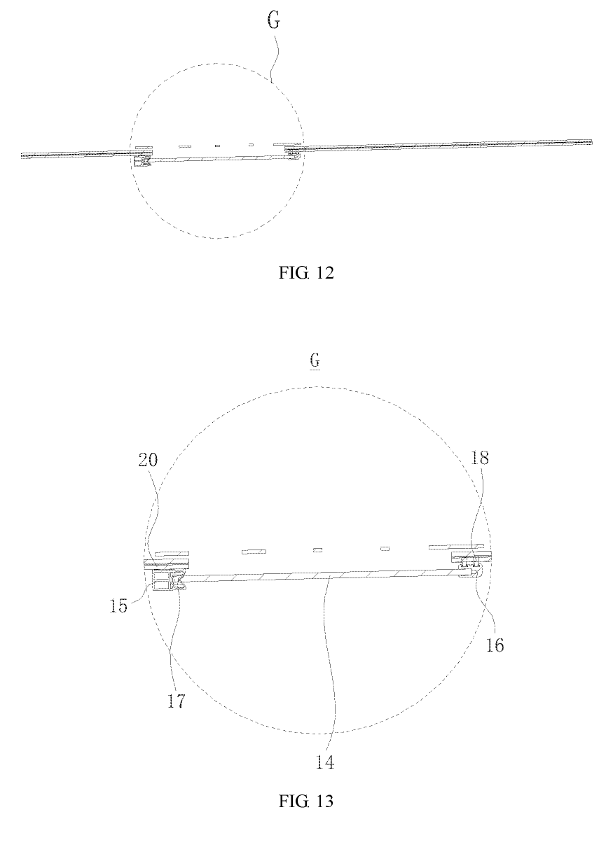

Referring to FIG. 1, FIG. 8 to FIG. 10, and FIG. 12 and FIG. 13, further, the sliding window 10 further includes a side frame strip 15, a middle frame strip 16, a second sealing member 17, and a third sealing member 18. Opposite ends of the side frame strip 15 are connected to an end of the first frame strip 11 and an end of the second frame strip 12, respectively. The side frame strip 15 is provided with a second mounting groove. The second sealing member 17 is received in the second mounting groove and is detachably connected to a third side portion 143 of the glass 14. The middle frame strip 16 is movably disposed between the first frame strip 11 and the second frame strip 12. The middle frame strip 16 is provided with a third mounting groove. The third sealing member 18 is disposed in the third mounting groove and is connected to a fourth side portion 144 of the glass 14.

That is, the first frame strip 11, the second frame strip 12, the side frame strip 15, and the middle frame strip 16 can be assembled and fixed to the four sides of the rectangular glass 14, respectively, thereby achieving stable mounting of the glass 14. The second sealing member 17 and the third sealing member 18 are configured to realize positioning and assembling of the glass 14 with the side frame strip 15 and the middle frame strip 16, providing cushioning, shock absorption, and sealing effects for the glass 14. When the glass 14 is pushed or pulled, the middle frame strip 16 and the third sealing member 18 synchronize with the glass 14, the second sealing member 17 and the third sealing member 18 maintains a sealed contact with a laminated glass 20 at all times, thereby ensuring the waterproof and dustproof properties of the sliding window 10.

For example, the first sealing member 116, the second sealing member 17, and the third sealing member 18 can be, but are not limited to, herringbone strips, siliconized strips, or aluminum strips.

Referring to FIG. 1, in addition, on the basis of any of the aforementioned embodiments, the sliding window 10 further includes a window lock 19 disposed on the glass 14. The second frame strip 12 is provided with a plurality of engaging openings 121 spaced apart on the second frame strip 12 along the opening and closing direction of the glass 14. The window lock 19 can be locked in or unlocked from any of the engaging openings 121. In actual use, the sliding window 10 is engaged with and mounted together with the laminated glass 20. The glass 14 is configured to open or close a window opening 21 defined on the laminated glass 20. When the glass 14 is pushed in the opening sliding direction, the glass 14 opens the window opening 21. The window lock 19 is locked with the engaging openings 121 at different positions, thereby securely securing the glass 14 in its current open position, which effectively secures the glass 14 in various opening positions. Conversely, when the glass 14 moves in the closing sliding direction opposite to the opening sliding direction, the glass 14 closes the window opening 21.

In one embodiment, the window lock 19 adopts a structure similar to a spring lock. When a button of the window lock 19 is mounted, the lock core of the window lock 19 retracts into the lock housing in conjunction with the button, thus separating the lock core from the engaging opening 121 and allowing the glass 14 to move freely. When the glass 14 is pushed or pulled to the desired position, the button is released, and the lock core automatically extends out of the lock housing under the action of the spring force and is engaged and locked with one of the engaging openings 121. The structure and operating principle of the window lock 19 are simple, making operation convenient and labor-saving, with a high degree of automation.

Referring to FIG. 1 and FIG. 10, the sliding window 10 further includes a guide strip 19a and a slider 19b. The guide strip 19a is provided with a guide groove, the slider 19b is embedded into the guide groove, and the slider 19b is slidably engaged with the second frame strip 12. This improves the smoothness of the sliding of the glass 14, reduces the force required to push or pull the glass 14, and enhances the user experience.

Optionally, the first profile 112 and the second profile 113 may be, but are not limited to, aluminum profiles.

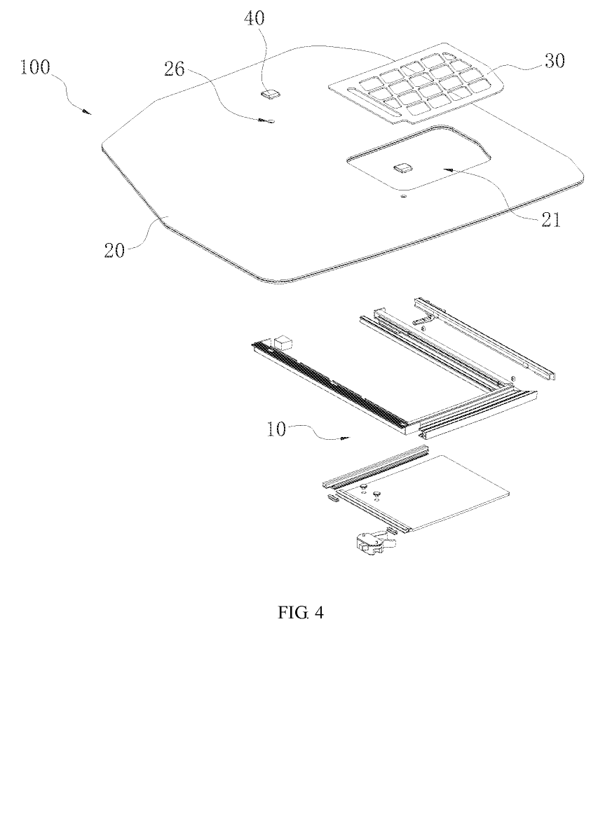

Referring to FIG. 4, in addition, a second aspect of the present disclosure further provides a vehicle window assembly 100. The vehicle window assembly 100 includes the laminated glass 20 providing with the window opening 21 and the sliding window 10 as described in any of the above embodiments. The sliding window 10 is disposed on the laminated glass 20 corresponding to the window opening 21, and the glass 14 can open or close the window opening 21.

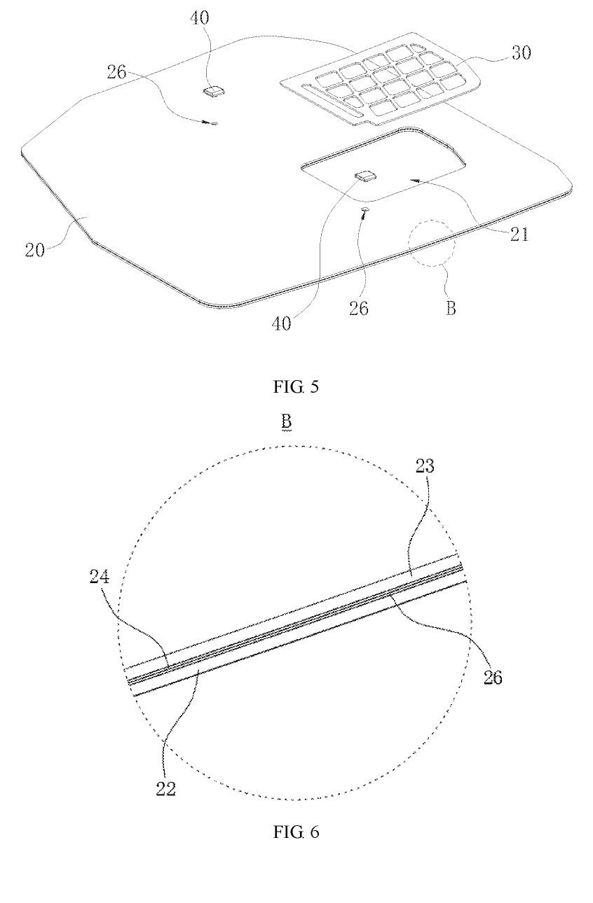

Referring to FIG. 5 and FIG. 6, in one embodiment, the laminated glass 20 includes an inner sheet glass 22, an outer sheet glass 23, an anti-UV film 24, and a soundproofing film 25. The anti-UV film 24 and the soundproofing film 25 are sandwiched between the inner sheet glass 22 and the outer sheet glass 23. Specifically, the outer sheet glass 23 is chemically tempered glass, which can provide a stress layer of approximately 30 MPa on a surface of the outer sheet glass 23, thus effectively preventing small particles from breaking through the outer sheet glass 23. The inner sheet glass 22 is semi-tempered glass, thereby increasing strength of the inner sheet glass 22 and ensuring the adhesion of components such as profiles to the surface of the inner sheet glass 22, which effectively prevents splinters.

The anti-UV film 24 and the soundproofing film 25 are two layers of PVB film, which can absorb flatness deviations caused by tempering on the one hand and block UV rays and noise on the other hand.

Referring to FIG. 4 and FIG. 5, in addition, the vehicle window assembly 100 also includes a grille member 30 and a decorative cover 40. The grille member 30 is mounted within window opening 21. The laminated glass 20 is further provided with a drain outlet 26, and the decorative cover 40 covers the drain outlet 26. The grille member 30 provides a barrier and protection function, preventing passengers inside the vehicle from dangerously reaching their hands, objects and the like outside through the window opening 21. It can also prevent flying insects and the like from outside the vehicle from entering the vehicle. The drain outlet 26 is configured to drain accumulated water within the laminated glass 20. The decorative cover 40 covers and conceals the drain outlet 26, enhancing the aesthetics appearance of the vehicle window assembly 100.

In addition to the above, a third aspect of the present disclosure further provides a vehicle, including a vehicle body and the vehicle window assembly 100 as described above. The vehicle window assembly 100 is arranged on the vehicle body.

The technical features of the aforementioned embodiments may be combined arbitrarily. To simplify the description, not all the possible combinations of the technical features in the aforementioned embodiments are described. However, all of the combinations of these technical features should be considered as within the scope of the present disclosure, as long as such combinations do not contradict with each other.

The above embodiments merely illustrate several embodiments of the present disclosure, and the description thereof is specific and detailed, but it shall not be constructed as limiting the scope of the disclosure. It should be noted that, for a person of ordinary skill in the art, several variations and improvements may be made without departing from the concept of the present disclosure, and these are all within the protection scope of the present disclosure. Therefore, the protection scope of the present disclosure shall be subject to the appended claims.

What is claimed is:

1. A sliding window, comprising:
a window frame comprising a first frame strip and a second frame strip that are arranged side by side and spaced apart from each other, the first frame strip comprising a limiting lock, a first profile, and a second profile, the first profile being arranged on a side of the second profile adjacent to the second frame strip, the first profile and the second profile being removably assembled, and the limiting lock being configured to lock or unlock the first profile and the second profile; and
a glass having a first side portion and a second side portion that are opposite to each other, the first side portion being connected to the first profile, and the second side portion being detachably connected to the second frame strip;
wherein after the limiting lock unlocks the first profile and the second profile, the second profile is separated from the first profile, thereby allowing the glass to be detached from the second frame strip.

2. The sliding window according to claim 1, wherein the first profile is provided with a limit block on a side surface thereof facing the second profile, the second profile is provided with a sliding groove and a notch in communication with each other, the limit block is slidably disposed within the sliding groove, and after the limiting lock unlocks the first profile and the second profile, the first profile slides relative to the second profile in a predetermined direction, so as to drive the limit block to slide from the sliding groove to the notch, thereby allowing the limit block to be released from the notch.

3. The sliding window according to claim 1, wherein the limiting lock comprises a lock seat, a lock handle, and a lock tongue, the lock seat is disposed on the second profile, the lock handle is rotatably disposed on the lock seat and is connected to the lock tongue, the first profile is provided with a lock opening, the limiting lock has a locked state locking the first profile and the second profile, and an unlocked state unlocking the first profile and the second profile, wherein when the limiting lock is in the locked state, the lock tongue is engaged in the lock opening, and when the limiting lock is in the unlocked state, the lock tongue is withdrawn from the lock opening.

4. The sliding window according to claim 1, wherein the limiting lock comprises a lock seat, a lock handle, and a lock tongue, the lock seat is disposed on the first profile, the lock handle is rotatably disposed on the lock seat and is connected to the lock tongue, the second profile is provided with a lock opening, the limiting lock has a locked state locking the first profile and the second profile, and an unlocked state unlocking the first profile and the second profile, wherein when the limiting lock is in the locked state, the lock tongue is engaged in the lock opening, and when the limiting lock is in the unlocked state, the lock tongue is withdrawn from the lock opening.

5. The sliding window according to claim 1, wherein the limiting lock comprises a lock seat, a lock handle, and a lock tongue, the lock seat is disposed on the second profile, the lock handle is rotatably mounted on the lock seat and is connected to the lock tongue, the first profile is provided with a lock latch, the lock latch is provided with a lock opening, and a surface of the lock latch is provided with an unlock indicator;
wherein the limiting lock has a locked state locking the first profile and the second profile, and an unlocked state unlocking the first profile and the second profile, when the limiting lock is in the locked state, the lock tongue is engaged with the lock opening, and the lock handle is pressed against the lock latch, when the limiting lock is in the unlocked state, the lock tongue is withdrawn from the lock opening.

6. The sliding window according to claim 2, wherein the limiting lock comprises a baffle, a lock block, and a threaded component, the second profile is provided with an engaging opening, the lock block is provided with a hook portion and a threaded hole, the lock block is mounted on the baffle, the hook portion is engaged in the engaging opening, the threaded component extends through a through hole of the baffle and is screwed into the threaded hole, and the threaded component presses against the baffle, such that the baffle abuts against a same ends of the first profile and the second profile.

7. The sliding window according to claim 2, wherein an outer peripheral wall of the limit block is provided with a conical surface, opposite side walls of the sliding groove are provided with inclined surfaces, and the inclined surfaces are configured to be engaged with the conical surface.

8. The sliding window according to claim 2, wherein the first frame strip further comprises a stop block, and the stop block is arranged on a side of the notch away from the sliding groove along the predetermined direction.

9. The sliding window according to claim 1, wherein the first frame strip further comprises a first sealing member, the first profile is provided with a first mounting groove on a side surface thereof facing the second frame strip, and the first sealing member is received in the first mounting groove and is connected to the first side portion.

10. The sliding window according to claim 9, further comprising a side frame strip and a second sealing member, wherein opposite ends of the side frame strip are connected to an end of the first frame strip and an end of the second frame strip, respectively, the side frame strip is provided with a second mounting groove, and the second sealing member is received in the second mounting groove and is detachably connected to a third side portion of the glass.

11. The sliding window according to claim 10, further comprising a middle frame strip and a third sealing member, wherein the middle frame strip is movably disposed between the first frame strip and the second frame strip, the middle frame strip is provided with a third mounting groove, and the third sealing member is disposed in the third mounting groove and is connected to a fourth side portion of the glass.

12. The sliding window according to claim 1, further comprising a window lock disposed on the glass, wherein the second frame strip is provided with a plurality of engaging openings arranged spaced apart on the second frame strip along a sliding direction of the glass, and the window lock is capable of locking or unlocking with any of the plurality of engaging openings.

13. The sliding window according to claim 1, further comprising a guide strip and a slider, wherein the guide strip is provided with a guide groove, and the slider is embedded in the guide groove and is capable of sliding on the second frame strip.

14. A vehicle window assembly, comprising:
a laminated glass provided with a window opening; and
the sliding window according to claim 1, wherein the sliding window is disposed on the laminated glass corresponding to the window opening, and the glass is capable of opening or closing the window opening.

15. The vehicle window assembly according to claim 14, wherein the laminated glass comprises an inner sheet glass, an outer sheet glass, an anti-UV film, and a soundproofing film, and the anti-UV film and the soundproofing film are laminated and sandwiched between the inner sheet glass and the outer sheet glass.

16. The vehicle window assembly according to claim 15, wherein the outer sheet glass is made of chemically strengthened glass, and the inner sheet glass is made of semi-tempered glass.

17. The vehicle window assembly according to claim 14, further comprising a member and a decorative cover, wherein the grille member is mounted in the window opening, the laminated glass further comprises a drain outlet, and the decorative cover covers the drain outlet.

18. A vehicle, comprising:
a vehicle body; and
the vehicle window assembly according to claim 14 provided on the vehicle body.
